(19) United States
(12) Patent Application Publication
(10) Pub. No.: US 2020/0207328 A1
(43) Pub. Date: Jul. 2, 2020

(54) CONTROL APPARATUS OF HYBRID VEHICLE

(71) Applicant: Honda Motor Co., Ltd., Tokyo (JP)

(72) Inventors: Takashi Adachi, Wako-shi (JP); Hisashi Ishikawa, Wako-shi (JP); Tomoyuki Noguchi, Wako-shi (JP); Masayuki Sadakiyo, Wako-shi (JP)

(21) Appl. No.: 16/716,056

(22) Filed: Dec. 16, 2019

(30) Foreign Application Priority Data
Dec. 28, 2018 (JP) 2018-246756

(51) Int. Cl. B60W 20/15; B60K 1/02; B60K 17/354; B60L 58/12; B60W 10/06; B60W 10/08

(52) U.S. Cl. CPC B60W 20/15; B60K 1/02; B60K 17/354; B60W 2510/087; B60W 10/06; B60W 10/08; B60L 58/12

(57) ABSTRACT

A control apparatus of a hybrid vehicle including a temperature detection part detecting a temperature of a first motor-generator, and a microprocessor. The microprocessor is configured to perform controlling an internal combustion engine, the first motor-generator and a second motor-generator so that the hybrid vehicle travels in accordance with a required driving force, outputting a request for temperature increase suppression of the first motor-generator based on the temperature of the first motor-generator, and the controlling including controlling the internal combustion engine, the first motor-generator and the second motor-generator so that power generation amount of the first motor-generator is reduced, the second motor-generator generates an electric power by a regenerative torque and a driving force of the internal combustion engine increases by an amount corresponding to the regenerative torque when the request for the temperature increase suppression is output.

### CROSS-REFERENCE TO RELATED APPLICATION

This application is based upon and claims the benefit of priority from Japanese Patent Application No. 2018-246756 filed on Dec. 28, 2018, the content of which is incorporated herein by reference.

### BACKGROUND OF THE INVENTION

### Field of the Invention

This invention relates to a control apparatus of a hybrid vehicle.

### Description of the Related Art

Conventionally, there is a known hybrid vehicle that includes an engine for driving front wheels, a power-generation-capable motor for driving front wheels, and a power-generation-capable motor for driving rear wheels. Such a vehicle is described, for example, in Japanese Unexamined Patent Publication No. 2005-161961 (JP2005-161961A). In the hybrid vehicle described in JP2005-161961A, motor maximum torque is limited to a lower value when motor temperature is a predetermined temperature or higher than when motor temperature is lower than the predetermined temperature.

However, when maximum motor torque is limited as prescribed by JP2005-161961A, electric power generation during operation of the motor as a generator declines, with the result that total electric power required by the whole vehicle cannot be efficiently secured and residual battery charge may become deficient.

### SUMMARY OF THE INVENTION

An aspect of the present invention is a control apparatus of a hybrid vehicle. The hybrid vehicle includes an internal combustion engine and a first motor-generator configured to respectively drive one wheels of front wheels and rear wheels, and a second motor-generator configured to drive the other wheels of the front wheels and the rear wheels. The control apparatus includes: a temperature detection part configured to detect a temperature of the first motor-generator; and an electronic control unit including a microprocessor and a memory connected to the microprocessor. The microprocessor is configured to perform: controlling the internal combustion engine, the first motor-generator and the second motor-generator so that the hybrid vehicle travels in accordance with a required driving force; outputting a request for a temperature increase suppression of the first motor-generator based on the temperature of the first motor-generator detected by the temperature detection part; and the controlling including controlling the internal combustion engine, the first motor-generator and the second motor-generator, so as to perform a first control in which the first motor-generator generates an electric power by a torque from the internal combustion engine when the request for the temperature increase suppression is not output, while so as to perform a second control in which a power generation amount of the first motor-generator generated by the torque from the internal combustion engine is reduced, the second motor-generator generates an electric power by a regenerative torque and a driving force of the internal combustion engine increases by an amount corresponding to the regenerative torque when the request for the temperature increase suppression is output.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle incorporating a control apparatus according to an embodiment of the invention;

FIG. 2 is a block diagram schematically illustrating overall configuration of a vehicle control system controlling the self-driving vehicle of FIG. 1;

FIG. 3 is a time chart showing an example of operation where charge of a battery becomes insufficient;

FIG. 4 is a block diagram showing main configurations of the control apparatus of the hybrid vehicle according to the present embodiment;

FIG. 5 is a flowchart showing an example of processing performed by a controller of FIG. 4;

FIG. 6A is a time chart showing an example of actions performed by the control apparatus of the hybrid vehicle according to the embodiment of the invention; and

FIG. 6B is a time chart showing a comparative example of FIG. 6A.

### DETAILED DESCRIPTION OF THE INVENTION

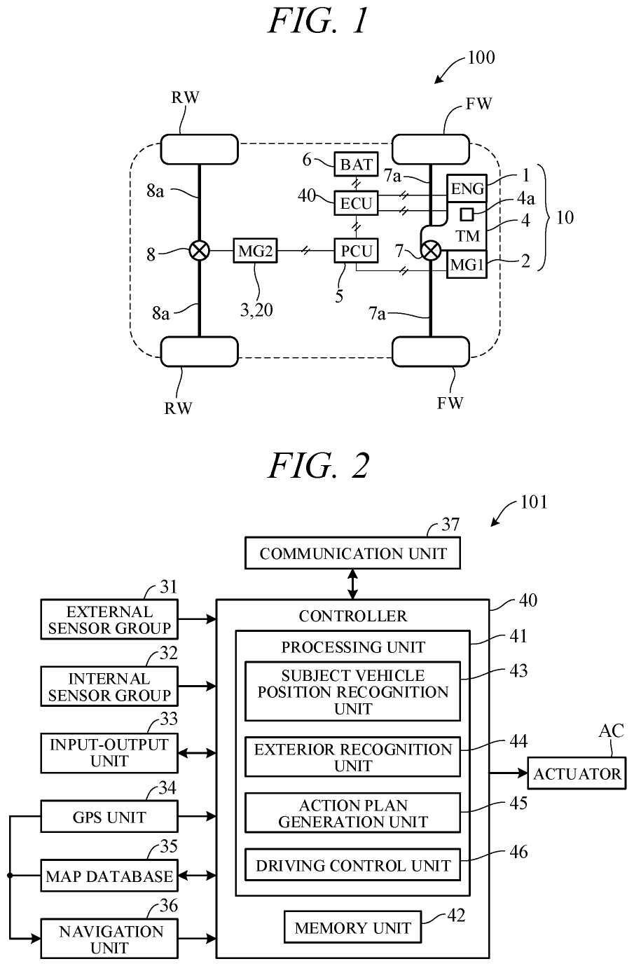

Hereinafter, an embodiment of the present invention is explained with reference to FIGS. 1 to 6B. FIG. 1 is a diagram showing a configuration overview of a driving system of a self-driving vehicle (also called “vehicle” or “subject vehicle”) 100 incorporating a control apparatus according to an embodiment of the present invention. The vehicle 100 is not limited to driving in a self-drive mode requiring no driver driving operations but is also capable of driving in a manual drive mode by driver operations.

As shown in FIG. 1, the vehicle 100 includes an internal combustion engine (ENG) 1, a first motor-generator (MG1) 2 and a second motor-generator (MG2) 3 as driving power sources, and is configured as a hybrid vehicle. More specifically, the engine 1, a transmission (TM) 4 and the first motor-generator 2 are mounted on front side of the vehicle 100 and are configured as a front drive unit 10 to drive front wheels FW. The second motor-generator 3 is mounted on rear side of the vehicle 100 and is configured as a rear drive unit 20 to drive rear wheels RW. Therefore, the vehicle 100 is configured as a four-wheel drive vehicle having front drive wheels FW and rear drive wheels RW.

The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. Air intake volume is metered by the throttle valve. An opening angle of the throttle valve (throttle opening angle) is changed by a throttle actuator operated by an electric signal. The opening angle of the throttle valve and an amount of fuel injected from the injector (injection timing and injection time) are controlled by a controller (ECU) 40.

The first and second motor-generators 2 and 3 each has a rotor and a stator and can function as a motor and as a generator. Namely, the rotors of the first and second motor-generators 2 and 3 are driven by electric power supplied from a battery (BAT) 6 through a power control unit (PCU) 5 to coils of the stators. In such case, the first and second motor-generators 2 and 3 function as motors.

On the other hand, when rotating shafts of rotors of the first and second motor-generators 2 and 3 are driven by external forces (engine 1, front wheels FW, or rear wheels RW), the first and second motor-generators 2 and 3 generate electric power that is applied through the power control unit 5 to charge the battery 6. In such case, the first and second motor-generators 2 and 3 function as generators. The power control unit 5 incorporates an inverter controlled by instructions from the controller 40 so as to individually control driving torque or regenerative torque of the first motor-generator 2 and the second motor-generator 3.

The transmission 4 is an automatic transmission which varies and outputs speed ratio of rotation of from the engine 1, and converts and outputs torque from the engine 1. The transmission 4 is, for example, a stepped transmission enabling stepwise speed ratio (gear ratio) shifting in accordance with multiple speed stages. Optionally, a continuously variable transmission enabling stepless speed ratio shifting can be used as the transmission 4. Although omitted in the drawings, power from the engine 1 can be input to the transmission 4 through a torque converter.

The transmission 4 can, for example, incorporate shift changing and drive power transmitting multiple (only one is shown) clutch mechanisms 4a such as dog clutch or friction clutch. The clutch mechanisms 4a are configured so as to operate by hydraulic pressure. A control valve is switched in accordance with instructions from the controller 40 to control an oil flow to the shift changing clutch mechanism 4a from a hydraulic pressure source (such as oil pump), whereby a speed stage of the transmission 4 can be changed to a target speed stage. The target speed stage is determined based on vehicle speed and required driving force, in accordance with a predetermined shift map.

A rotating shaft of the first motor-generator 2 is connected through the drive power transmitting clutch mechanism 4a to the transmission 4, whereby torque of the first motor-generator 2 can be input to the transmission 4. Moreover, rotating shafts of the engine 1 and first motor-generator 2 are connected via the drive power transmitting clutch mechanism 4a of the transmission 4, whereby the first motor-generator 2 can be rotated to generate electric power by torque from the engine 1. The first motor-generator 2 can also be driven to generate electric power by regenerative torque during braking. Torque output from the transmission 4 when driven by one or both of the engine 1 and the first motor-generator 2 is transmitted through a differential mechanism 7 and right and left drive shafts 7a to the front wheels FW.

Drive mode of the front drive unit 10 can be switched among engine mode in which the engine 1 is sole travel power source of the front wheels FW, EV mode in which the first motor-generator 2 is sole travel power source of the front wheels FW, and hybrid mode in which the engine 1 and the first motor-generator 2 are both travel power sources of the front wheels FW. In engine mode, power of the engine 1 is partially transmitted through the drive power transmitting clutch mechanism 4a to the first motor-generator 2 so as to generate electric power while propelling the front wheels FW. The controller 40 implements drive mode switching by deciding optimum drive mode based on, inter alia, vehicle speed, required driving force and residual charge of the battery 6 and by controlling operation of the clutch mechanism 4a and the like to establish the decided driving mode.

The torque output from the second motor-generator 3 is transmitted to rear wheels FW through a differential unit 8 and left and right drive shafts. The second motor-generator 3 can generate electric power by being driven by the torque of rear wheels RW. Optionally, the second motor-generator 3 is configured as in-wheel motor and left and right rear wheels RW respectively incorporate the second motor-generators 3 therein. The first motor-generator 2 can be configured as in-wheel motor.

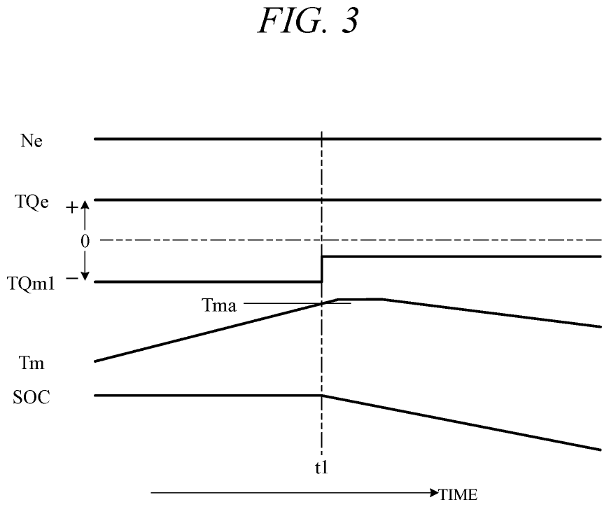

FIG. 2 is a block diagram schematically illustrating basic overall configuration of a vehicle control system 101 for controlling the self-driving vehicle 100. As shown in FIG. 2, the vehicle control system 101 includes mainly the controller 40, and as members communicably connected with the controller 40 through CAN (Controller Area Network) communication or the like, an external sensor group 31, an internal sensor group 32, an input-output unit 33, a GPS unit 34, a map database 35, a navigation unit 36, a communication unit 37, and actuators AC for traveling.

The term external sensor group 31 herein is a collective designation encompassing multiple sensors (external sensors) for detecting external circumstances constituting vehicle ambience data. For example, the external sensor group 31 includes, inter alia, a LIDAR (Light Detection and Ranging) for measuring distance from the vehicle 100 to ambient obstacles by measuring scattered light produced by laser light radiated from the vehicle 100 in every direction, a RADAR (Radio Detection and Ranging) for detecting other vehicles and obstacles around the vehicle 100 by radiating electromagnetic waves and detecting reflected waves, and cameras having a CCD, CMOS or other image sensor and attached to the vehicle 100 for imaging ambience (forward, reward and sideways) of the vehicle 100. Signals from the external sensor group 31 are input to the controller 40.

The term internal sensor group 32 herein is a collective designation encompassing multiple sensors (internal sensors) for detecting driving state of the vehicle 100. For example, the internal sensor group 32 includes, inter alia, a vehicle speed sensor for detecting vehicle speed of the vehicle 100 and acceleration sensors for detecting forward-rearward direction acceleration and lateral acceleration of the vehicle 100, respectively, rotational speed sensor for detecting rotational speed of the engine 1, a yaw rate sensor for detecting rotation angle speed around a vertical axis through center of gravity of the vehicle 100, a throttle opening angle sensor for detecting an opening angle of the throttle valve (throttle opening angle), temperature sensors for detecting temperatures of some portions, and a battery sensor for detecting a state of charge of the battery 6. The internal sensor group 32 also includes sensors for detecting driver driving operations in manual drive mode, including, for example, accelerator pedal operations, brake pedal operations, steering wheel operations and the like. Signals from the internal sensor group 32 are input to the controller 40.

The term input-output unit 33 is used herein as a collective designation encompassing apparatuses receiving instructions input by the driver and outputting information to the driver. The input-output unit 33 includes, inter alia, switches which the driver uses to input various instructions, a microphone which the driver uses to input voice instructions, a display for presenting information to the driver via displayed images, and a speaker for presenting information to the driver by voice. The switch of the input-output unit 33 includes a self/manual drive select switch for instructing a self-drive mode or manual drive mode.

The self/manual drive select switch, for example, is configured as a switch manually operable by the driver to output an instruction of switching to a self-drive mode enabling self-drive functions or a manual drive mode disabling self-drive functions in accordance with operation of the switch. Optionally, the self/manual drive select switch can be configured to instruct switching from manual drive mode to self-drive mode or from self-drive mode to manual drive mode without operating the self/manual drive select switch. For example, when a predetermined operation is made by a driver or a predetermined condition is satisfied, drive mode can be switched automatically to self-drive mode or manual drive mode. Signals from the input-output unit 33 are input to the controller 40. The controller 40 outputs to the input-output unit 33.

The GPS unit 34 includes a GPS receiver (GPS sensor) for receiving position determination signals from multiple GPS satellites, and measures absolute position (latitude, longitude and the like) of the vehicle 100 based on the signals received from the GPS receiver. Signals from the GPS unit 34 are input to the controller 40.

The map database 35 is a unit storing general map data used by the navigation unit 36 and is, for example, implemented using a hard disk. The map data include road position data and road shape (curvature etc.) data, along with intersection and road branch position data. The map data stored in the map database 35 are different from high-accuracy map data stored in a memory unit 42 of the controller 40.

The navigation unit 36 retrieves target road routes to destinations input by the driver and performs guidance along selected target routes. Destination input and target route guidance is performed through the input-output unit 33. Target routes are computed based on current position of the vehicle 100 measured by the GPS unit 34 and map data stored in the map database 35. Signals from the navigation unit 36 are input to the controller 40.

The communication unit 37 communicates through networks including the Internet and other wireless communication networks to access servers (not shown in the drawings) to acquire map data, traffic data and the like, periodically or at arbitrary times. Acquired map data are output to the map database 35 and/or memory unit 42 via the controller 40 to update their stored map data. Acquired traffic data include congestion data and traffic light data including, for instance, time to change from red light to green light.

The actuators AC are actuators for operating various devices in relation to vehicle traveling, i.e., for traveling of the vehicle 100, and operate in accordance with electrical signals from the controller 40. The actuators AC include a throttle actuator for adjusting opening angle of the throttle valve of the engine 1 (throttle opening angle), the first and second motor-generators 2 and 3, a transmission actuator for operating the clutch mechanism 4a of the transmission 4, a brake actuator for operating a braking device, the turning actuator for turning the front wheels FW, for example. These actuators can be configured by electric motors or control valves controlling a flow of hydraulic pressure for driving the actuators.

The controller 40 is constituted by an electronic control unit (ECU). In FIG. 2, the controller 40 is integrally configured by consolidating multiple function-differentiated ECUs such as an engine control ECU, a transmission control ECU and so on. Optionally, these ECUs can be individually provided. The controller 40 incorporates a computer including a CPU or other processing unit (a microprocessor) 41 for executing a processing in relation to travel control, the memory unit (a memory) 42 of RAM, ROM, hard disk and the like, and an input-output interface or other peripheral circuits not shown in the drawings.

The memory unit 42 stores high-accuracy detailed map data including, inter alia, lane center position data and lane boundary line data. More specifically, road data, traffic regulation data, address data, facility data, telephone number data, parking are data and the like are stored as map data. The road data include data identifying roads by type such as expressway, toll road and national highway, and data on, inter alia, number of road lanes, individual lane width, road gradient, road 3D coordinate position, lane curvature, lane merge and branch point positions, and road signs. The traffic regulation data include, inter alia, data on lanes subject to traffic restriction or closure owing to construction work and the like. The memory unit 42 also stores a shift map (shift chart) serving as a shift operation reference, various programs for performing processing, and threshold values used in the programs, etc.

As functional configurations in relation to mainly self-driving, the processing unit 41 includes a subject vehicle position recognition unit 43, an exterior recognition unit 44, an action plan generation unit 45, and a driving control unit 46.

The subject vehicle position recognition unit 43 recognizes map position of the vehicle 100 (subject vehicle position) based on subject vehicle position data calculated by the GPS unit 34 and map data stored in the map database 35. Optionally, the subject vehicle position can be recognized using map data (building shape data and the like) stored in the memory unit 42 and ambience data of the vehicle 100 detected by the external sensor group 31, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 37.

The exterior recognition unit 44 recognizes external circumstances around the vehicle 100 based on signals from cameras, LIDERs, RADARs and the like of the external sensor group 31. For example, it recognizes position, speed and acceleration of nearby vehicles (forward vehicle or rearward vehicle) driving in the vicinity of the vehicle 100, position of vehicles stopped or parked in the vicinity of the vehicle 100, and position and state of other objects. Other objects include traffic signs, traffic lights, road boundary and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 45 generates a driving path (target path) of the vehicle 100 from present time point to a certain time ahead based on, for example, a target route computed by the navigation unit 36, subject vehicle position recognized by the subject vehicle position recognition unit 43, and external circumstances recognized by the exterior recognition unit 44. When multiple paths are available on the target route as target path candidates, the action plan generation unit 45 selects from among them the path that optimally satisfies legal compliance, safe efficient driving and other criteria, and defines the selected path as the target path. The action plan generation unit 45 then generates an action plan matched to the generated target path. An action plan is also called “travel plan”.

The action plan includes action plan data set for every unit time (e.g., 0.1 sec) between present time point and a predetermined time period (e.g., 5 sec) ahead, i.e., includes action plan data set in association with every unit time interval. The action plan data include position data of the vehicle 100 and vehicle state data for every unit time. The position data are, for example, target point data indicating 2D coordinate position on road, and the vehicle state data are vehicle speed data indicating vehicle speed, direction data indicating direction of the vehicle 100, and the like. Action plan is updated every unit time.

The action plan generation unit 45 generates the target path by connecting position data at every unit time between present time point and predetermined time period (e.g., 5 sec) ahead in time order. Further, the action plan generation unit 45 calculates acceleration (target acceleration) of sequential unit times, based on vehicle speed (target vehicle speed) corresponding to target point data of sequential unit times on target path. In other words, the action plan generation unit 45 calculates target vehicle speed and target acceleration. Optionally, the driving control unit 46 can calculate target acceleration.

The driving control unit 46 controls the actuators AC in accordance with drive mode (self-drive mode, manual drive mode). For example, in self-drive mode, the driving control unit 46 controls the actuators AC so that the vehicle 100 travels at target speed and target acceleration along target path generated by the action plan generation unit 45. Namely, the driving control unit 46 controls the throttle actuator, first and second motor-generators 2 and 3, transmission actuator, brake actuator and steering actuator so that the vehicle 100 travels through the target points of the unit times.

More specifically, in self-drive mode, the driving control unit 46 calculates required driving force for achieving the target accelerations at each unit time included in the action plan generated by the action plan generation unit 45, taking running resistance caused by road gradient and the like into account. And the actuators AC are feedback controlled to bring actual acceleration detected by the internal sensor group 32, for example, into coincidence with target acceleration. In other words, it controls the actuators AC so that the vehicle 100 travels at target vehicle speed and target acceleration. On the other hand, in manual drive mode, the driving control unit 46 controls the actuators AC in accordance with driving instructions by the driver (accelerator opening angle and the like) acquired from the internal sensor group 32.

The so-configured self-driving vehicle 100 incorporates numerous sensors and load on its computer for processing sensor signals is accordingly high. Therefore, since electric power consumption is also high, much power needs to be generated for meeting this consumption. The resulting heavy load on the first and second motor-generators 2 and 3 leads to a lot of heat generation. The first motor-generator 2 is particularly likely to overheat because it is installed near and driven by the engine 1.

Although coils of the first and second motor-generators 2 and 3 are cooled by ATF oil or the like, their temperatures may nevertheless exceed upper limit temperature when heat generation is great. When temperature of the first and second motor-generators 2 and 3 (particularly that of the first motor-generator 2) exceeds upper limit temperature, a protection function activates to reduce power generation amount. Since this makes adequate power generation impossible, charge of the battery 6 is apt to become insufficient.

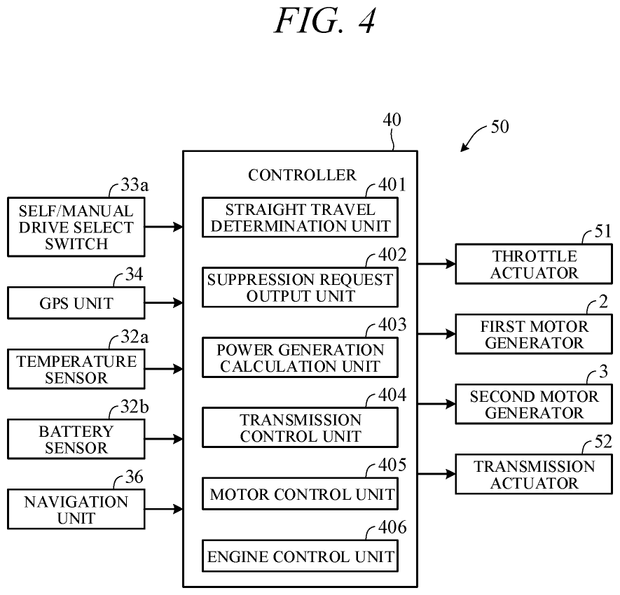

FIG. 3 is a time chart showing an example of this phenomenon. FIG. 3 shows the vehicle 100 in condition of traveling at constant engine speed Ne and constant engine torque TQe output from the engine 1. In this state, torque of the first motor-generator 2 (first motor torque TQm1) is negative, and the first motor-generator 2 is rotationally driven to generate electric power by torque from the engine 1. State of charge (SOC) of the battery 6 can therefore be maintained at constant value. In this case, engine torque TQe is either larger than or equal to absolute value of first motor torque TQm1.

When temperature of the first motor-generator 2 (first motor temperature Tm) increases over time and reaches threshold Tma at time t1, regenerative torque (absolute value) of the first motor-generator 2 is lowered in order to prevent temperature of the first motor-generator 2 from rising. Therefore, since power generation amount by the first motor-generator 2 therefore decreases, charge of the battery 6 becomes insufficient. In order to avoid such charge deficiency of the battery 6, the control apparatus according to the present embodiment is configured as described in the following.

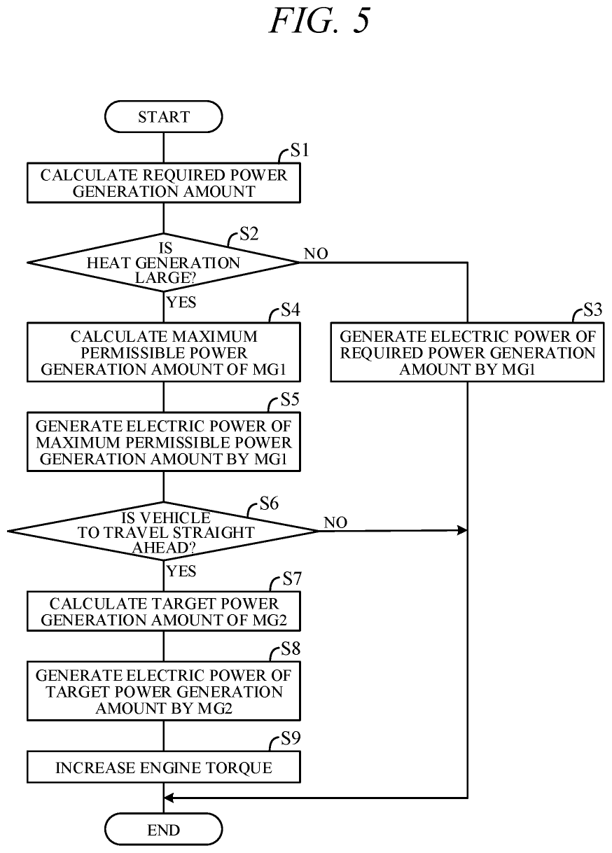

FIG. 4 is a block diagram showing main configurations of a hybrid vehicle control apparatus 50 according to the present embodiment. The control apparatus 50 of the hybrid vehicle is adapted to control traveling behavior of the vehicle 100 and is configured as part of the vehicle control system 101 of FIG. 2.

As shown in FIG. 4, the control apparatus 50 includes the controller 40 and, connected thereto, a self/manual drive select switch 33a, a GPS unit 34, a temperature sensor 32a, a battery sensor 32b, a navigation unit 36, a throttle actuator 51, the first motor-generator 2, the second motor-generator 3, and a transmission actuator 52. Although the first motor-generator 2 and second motor-generator 3 are connected to the controller 40 through the power control unit 5 (FIG. 1), illustration of the power control unit 5 is omitted in FIG. 4.

The temperature sensor 32a detects temperature of the first motor-generator 2 and sends a corresponding detection signal to the controller 40. The temperature sensor 32a is adapted to detect first motor temperature Tm (e.g., coil temperature or the like). Optionally, ambient temperature of the first motor-generator 2, temperature of ATF oil used to cool the first motor-generator 2, power consumption of the first motor-generator 2 or some other related factor can be detected and first motor temperature Tm be determined (estimated) from the detected value. In other words, first motor temperature Tm can alternatively be detected using a sensor or the like other than the temperature sensor 32a. The battery sensor 32b detects residual charge (SOC) of the battery 6 and sends a corresponding detection signal to the controller 40. The temperature sensor 32a and battery sensor 32b are members of the internal sensor group 32 of FIG. 2.

As functional constituents, the controller 40 includes a straight travel determination unit 401, a suppression request output unit 402, a power generation calculation unit 403, a transmission control unit 404, a motor control unit 405, and an engine control unit 406. The straight travel determination unit 401 is configured as, for example, a member of the action plan generation unit 45 of FIG. 2. The suppression request output unit 402, power generation calculation unit 403, transmission control unit 404, motor control unit 405 and engine control unit 406 are configured as, for example, members of the driving control unit 46 of FIG. 2.

The straight travel determination unit 401 uses a target route computed by the navigation unit 36 and current position of the vehicle 100 determined using a signal from the GPS unit 34 to determine whether the vehicle 100 is to travel straight ahead. More specifically, the action plan generation unit 45 uses, inter alia, target route and current position of the vehicle 100 to generate an action plan to predetermined time ahead, and when a target path included in the action plan generated by the action plan generation unit 45 is a straight line, the straight travel determination unit 401 determines that the vehicle 100 is to travel straight ahead.

The suppression request output unit 402 responds to detection by the battery sensor 32b that charge (SOC) of the battery 6 is predetermined value SOCa or lower by outputting a temperature increase suppression request when the temperature sensor 32a detects first motor temperature Tm of threshold Tma or higher. The reason for the suppression request output unit 402 outputting a suppression request in such a case is that power generation amount by the first motor-generator 2 needs to be lowered in order to inhibit increase of its temperature. Threshold Tma is, for example, a value obtained by multiplying upper limit temperature Tmb of the first motor-generator 2 by a predetermined safety factor of less than 1. Upper limit temperature Tmb (first predetermined temperature) is higher than threshold Tma (second predetermined temperature), i.e., Tmb>Tma.

The power generation calculation unit 403 calculates total power generation amount W0 required by the vehicle. Required power generation amount W0 is amount of electric power generation needed to meet current power consumption of the whole vehicle. Moreover, the power generation calculation unit 403 responds to output of a temperature increase suppression request from the suppression request output unit 402 by calculating maximum permissible power generation amount W1 of the first motor-generator 2 enabling suppression of first motor temperature Tm to not higher than upper limit temperature Tmb and by calculating target power generation amount W2 as difference obtained by subtracting maximum permissible power generation amount W1 from required power generation amount W0.

The transmission control unit 404 outputs a control signal to the transmission actuator 52 to operate the clutch mechanism 4a so as to implement drive mode decided by the controller 40 (one among engine mode, EV mode and hybrid mode). Moreover, in the present embodiment, when SOC of the battery 6 detected by the battery sensor 32b is predetermined value SOCa or lower and power generation by the first motor-generator 2 is required, i.e., when maximum permissible power generation amount W1 of the first motor-generator 2 calculated by the power generation calculation unit 403 is greater than 0, the transmission control unit 404 outputs a control signal to the transmission actuator 52 to input torque of the engine 1 through the transmission 4 to the first motor-generator 2.

The motor control unit 405 outputs control signals to the power control unit 5 to control the first and second motor-generators 2 and 3 to generate driving torque or regenerative torque in accordance with, inter alia, vehicle speed, required driving force, and battery SOC, thereby controlling driving of the first and second motor-generators 2 and 3. Moreover, in the present embodiment, when the suppression request output unit 402 outputs a temperature increase suppression request, the motor control unit 405 controls the first motor-generator 2 so that the first motor-generator 2 uses output torque of the engine 1 to generate electric power of maximum permissible power generation amount W1 calculated by the power generation calculation unit 403. At this time, the motor control unit 405 controls the second motor-generator 3 so that the second motor-generator 3 uses rotational torque of the rear wheels RW to generate electric power of target power generation amount W2 calculated by the power generation calculation unit 403.

The engine control unit 406 outputs a control signal to the throttle actuator 51 to control the engine 1 to output required driving force. Moreover, in the present embodiment, when the second motor-generator 3 generates electric power of target power generation amount W2 in accordance with instruction from the motor control unit 405, output torque of the engine 1 is increased to compensate for resulting decrease in overall vehicle traveling force.

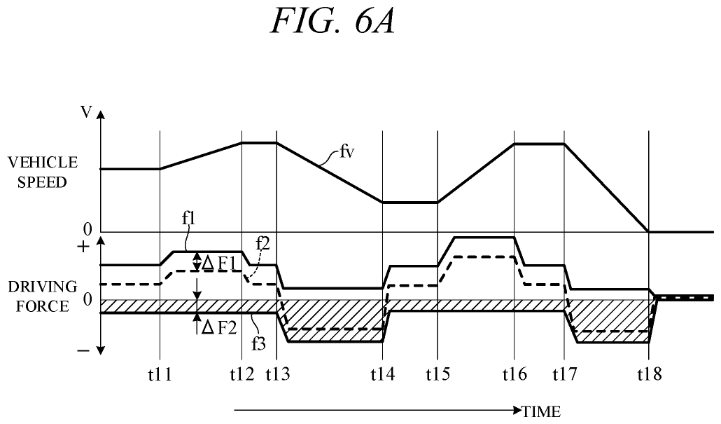

FIG. 5 is a flowchart showing an example of processing performed by the CPU of the controller 40 of FIG. 4 in accordance with a program stored in memory beforehand. The processing indicated in this flowchart is commenced when self-drive mode, for example, is selected by the self/manual drive select switch 33a under a condition requiring battery charging owing to SOC detected by the battery sensor 32b being predetermined value SOCa or lower, and is repeatedly performed periodically at predetermined intervals so long as this condition persists. More specifically, the processing of FIG. 5 is performed in a drive mode (e.g., engine mode) wherein the first motor-generator 2 can be driven to generate electric power by output torque of the engine 1. So when the processing of FIG. 5 is performed, a control signal is output to the transmission actuator 52 so as to input of part of the torque of the engine 1 through the transmission 4 to the first motor-generator 2.

First, in S1 (S: processing Step), the CPU calculates required power generation amount W0 of the vehicle 100. Next, in S2, the CPU determines whether heat generation of the first motor-generator 2 is large, i.e., whether first motor temperature Tm detected by the temperature sensor 32a is equal to or higher than threshold Tma. This determination amounts to ascertaining whether the suppression request output unit 402 output a temperature increase suppression request. When the result in S2 is NO, the program goes to S3, in which the CPU outputs a control signal to the first motor-generator 2 (power control unit 5) to generate electric power of required power generation amount W0 by the first motor-generator 2 with power from the engine 1.

On the other hand, when the result in S2 is YES, the program goes to S4, in which the CPU calculates maximum permissible power generation amount W1 of the first motor-generator 2. Next, in S5, the CPU outputs a control signal to the first motor-generator 2 to generate electric power of maximum permissible power generation amount W1 by the first motor-generator 2 with power from the engine 1. Next, in S6, the CPU determines whether the vehicle 100 is to travel straight ahead based on target route computed by the navigation unit 36 and current position of the vehicle 100 determined using a signal from the GPS unit 34.

When the result in S6 is YES, the program goes to S7, and when NO, processing is terminated. In S7, the CPU calculates target power generation amount W2 by subtracting maximum permissible power generation amount W1 calculated in S4 from required power generation amount W0 calculated in S1. Next, in S8, the CPU outputs a control signal to the second motor-generator 3 (power control unit 5) to regeneratively generate electric power of target power generation amount W2 by the second motor-generator 3. Next, in S9, the CPU outputs a control signal to the throttle actuator 51 in order to increase engine driving force (engine torque) so as to compensate for decrease in vehicle traveling force owing to performance of regenerative power generation by the second motor-generator 3, i.e., so as to generate required driving force in accordance with the action plan when the vehicle 100 travels in self-drive mode.

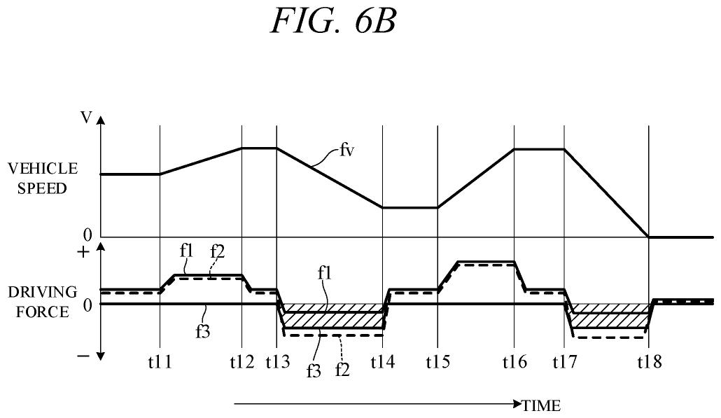

FIG. 6A is a time chart showing an example of behavior in the case of the control apparatus according to the present embodiment, and FIG. 6B shows behavior in the case of a comparative example thereof. Symbol “fv” in the drawings designates a characteristic curve representing change of vehicle speed V, symbol “f1” designates a characteristic curve (solid line) representing change of driving force of the engine 1, symbol “f2” designates a characteristic curve (dotted line) representing change of required driving force, and symbol “f3” designates a characteristic curve (solid line) representing change of driving force of the second motor-generator 3. Since the vehicle is controlled to output required driving force, required driving force corresponds to actual driving force during vehicle traveling. The second motor-generator 3 performs regenerative power generation at driving force in negative region (hatched region) and area of the hatched region corresponds to amount of regenerative power generation.

Behavior in the comparative example is explained first. In the comparative example, the second motor-generator 3 performs regenerative power generation at no time other than during braking of the vehicle 100. Therefore, as shown in FIG. 6B, driving force of the second motor-generator 3 is 0 during acceleration (between time t11 and t12, and time t15 and t16) and during cruising (between time t12 and t13, time t14 and t15, and time t16 and t17), and driving force of the second motor-generator 3 is negative during deceleration (braking) (between time t13 and t14, and time t17 and t18). Thus in the comparative example regenerative power generation is performed by the second motor-generator 3 only during vehicle deceleration, so that insufficient charge of the battery 6 arises when power generation by the first motor-generator 2 is restricted owing to overheating of the first motor-generator 2.

In contrast, the present embodiment is configured so that when the battery 6 requires charging at a time when temperature increase suppression of first motor-generator 2 is necessary, the second motor-generator 3 is made to perform regenerative power generation on condition of straight-ahead vehicle traveling, even in absence of braking (S8). Therefore, as shown in FIG. 6A, driving force of the second motor-generator 3 is negative not only during deceleration (between time t13 and t14, and time t17 and t18) but also during acceleration (between time t11 and t12, and time t15 and t16) and during cruising (between time t12 and t13, time t14 and t15, and time t16 and t17). As a result, power generation amount by the second motor-generator 3 increases and charge deficiency of the battery 6 can be resolved even when power generation by the first motor-generator 2 is restricted owing to overheating of the first motor-generator 2.

During vehicle acceleration and cruising at this time, decrease AF2 in driving force owing to power generation by the second motor-generator 3 and increase AF1 in driving force of the engine 1 are equal (S9). The vehicle 100 can therefore meet required driving force while traveling.

The present embodiment can achieve advantages and effects such as the following:

(1) The vehicle 100 is a hybrid vehicle including the engine 1 and the power-generation-capable first motor-generator 2 for driving the front wheels FW, and the power-generation-capable second motor-generator 3 for driving the rear wheels RW (FIG. 1). The control apparatus 50 of this hybrid vehicle includes the motor control unit 405 and engine control unit 406 for controlling the engine 1, first motor-generator 2 and second motor-generator 3 so that the vehicle 100 travels in accordance with required driving force, the temperature sensor 32a for detecting temperature Tm of the first motor-generator 2, and the suppression request output unit 402 for outputting a temperature increase suppression request of the first motor-generator 2 based on detection value of the temperature sensor 32a (FIG. 4). When no temperature increase suppression request is output by the suppression request output unit 402, the motor control unit 405 controls the first motor-generator 2 to generate electric power of required power generation amount W0 with power from the engine 1 (S3). Namely, it performs first control. On the other hand, when a temperature increase suppression request is output by the suppression request output unit 402, the motor control unit 405 controls the first motor-generator 2 and second motor-generator 3 so as to lower power generation amount of the first motor-generator 2 to maximum permissible power generation amount W1 and so that the second motor-generator 3 regeneratively generates electric power of target power generation amount W2 (S5 and S8), and additionally controls driving force of the engine 1 to increase by amount of regenerative torque of the second motor-generator 3, i.e., controls the engine 1 so that the vehicle 100 continues to travel at required driving force (S9). Namely, it performs second control.

This makes it possible to resolve charge deficiency of the battery 6 while simultaneously suppressing temperature increase of the first motor-generator 2. This is significant in view of the fact that when traveling for a long time on an expressway, for example, infrequency of power generation by regenerative braking of the vehicle 100 makes it necessary for the engine 1 to generate electricity by driving the first motor-generator 2, but this is not practical because the first motor-generator 2 is installed in a high-temperature environment near the engine and easily overheats. When temperature of the first motor-generator 2 rises excessively, power generation by the first motor-generator 2 has to be restricted in order to suppress temperature increase. In such a case, required electric power and required driving force are simultaneously realized by controlling the second motor-generator 3 located apart from the engine 1 to perform regenerative power generation even in absence of braking of the vehicle 100 and by also increasing driving force of the engine 1 (FIG. 6A).

(2) The control apparatus 50 of the hybrid vehicle is further equipped with the power generation calculation unit 403 for calculating required power generation amount W0 of the whole vehicle and calculating maximum permissible power generation amount W1 by the first motor-generator 2 for ensuring that first motor temperature Tm detected by the temperature sensor 32a is held to or below upper limit temperature Tmb (FIG. 4). When a temperature increase suppression request is output by the suppression request output unit 402, the motor control unit 405 controls the first motor-generator 2 and second motor-generator 3 so that the first motor-generator 2 generates electric power of maximum permissible power generation amount W1 calculated by the power generation calculation unit 403 and the second motor-generator 3 generates electric power of target power generation amount W2 obtained by subtracting maximum permissible power generation amount W1 from required power generation amount W0 calculated by the power generation calculation unit 403 (FIG. 5).

Since the first motor-generator 2 is driven by the engine 1 to generate electric power, its generation efficiency is higher than that of the second motor-generator 3 driven to generate electric power by rotation of the rear wheels RW. With consideration to this point, the present embodiment is adapted to obtain maximum permissible power generation amount W1 from the first motor-generator 2 and obtain any shortfall (W0-W1) from the second motor-generator 3. In other words, efficient generation of required electric power is achieved by preferential use of the first motor-generator 2 for power generation.

(3) The control apparatus 50 of the hybrid vehicle further includes the straight travel determination unit 401 for determining whether the vehicle 100 travels straight ahead (FIG. 4). When a temperature increase suppression request is output by the suppression request output unit 402 and it is determined by the straight travel determination unit 401 that the vehicle 100 travels straight ahead, the motor control unit 405 controls the second motor-generator 3 to perform regenerative power generation. On the other hand, when a temperature increase suppression request is output by the suppression request output unit 402 and it is determined by the straight travel determination unit 401 that the vehicle 100 does not travel straight ahead, the motor control unit 405 controls the second motor-generator 3 not to perform regenerative power generation.

Since the rearward second motor-generator 3 is thus controlled to perform regenerative power generation on condition of straight-ahead traveling, loss of traveling stability of the vehicle 100 can be prevented. A detailed explanation of this point follows. Where driving force (driving torque) of the engine 1 during regenerative traveling of the second motor-generator 3 is defined as, for example, +100 (unit omitted), driving force (regenerative torque) of the right rear wheel RW1 as, for example, −25, and driving force (regenerative torque) of the left rear wheel RW2 as, for example, −25, traveling force of the vehicle 100 is +50. If when in this state the vehicle 100 turns right, driving force of the right rear wheel RW1 becomes −10, for example, owing to smaller load acting on the right rear wheel RW1. As this results in a difference in driving force between the left and right rear wheels RW1 and RW2, traveling behavior of the vehicle 100 is destabilized. As the present embodiment deals with this issue by not performing regeneration at the rear other than during straight-ahead driving, destabilization of traveling behavior can be prevented.

(4) The control apparatus 50 of the hybrid vehicle further includes the navigation unit 36 for setting a target route and the GPS unit 34 for detecting position of the vehicle 100 (FIG. 4). The vehicle 100 is configured as a self-driving vehicle that travels autonomously along the target route defined by the navigation unit 36. The straight travel determination unit 401 determines whether the vehicle 100 travels straight ahead based on the target route set by the navigation unit 36 and the position of the vehicle 100 detected by the GPS unit 34. Since whether the vehicle 100 travels straight ahead can therefore be ascertained in advance, traveling stability upon implementation of rear regeneration can be reliably ensured.

Various modifications of the above embodiment are possible. Some examples are explained in the following. In the above embodiment, the engine 1 (an internal combustion engine) and the first motor-generator 2 for driving the front wheels FW are installed on front side of the vehicle, and the second motor-generator 3 for driving the rear wheels RW is installed on rear side of the vehicle. In other word, front wheels are driven by an internal combustion engine and a first motor-generator, and rear wheels are driven by a second motor-generator. However, the hybrid vehicle is configured so that rear wheels are driven by an internal combustion engine and a first motor-generator and front wheels are driven by a second motor-generator. Therefore, the configuration of the hybrid vehicle is not limited to the above configuration.

Although in the above embodiment, the engine control unit 406 and motor control unit 405 control the engine 1, first motor-generator 2 and second motor-generator 3 so that the vehicle 100 travels in accordance with required driving force, the configuration of a control unit is not limited to the above configuration. In other words, as long as controlling the internal combustion engine, the first motor-generator and the second motor-generator, so as to perform a first control in which the first motor-generator generates an electric power by a torque from the internal combustion engine when a request for a temperature increase suppression of the first motor-generator is not output, while so as to perform a second control in which a power generation amount of the first motor-generator generated by the torque from the internal combustion engine is reduced, the second motor-generator generates an electric power by a regenerative torque and a driving force of the internal combustion engine increases by an amount corresponding to the regenerative torque when the request for the temperature increase suppression is output, the control unit can be of any configuration.

In the above embodiment, the power generation calculation unit 403 calculates required power generation amount W0 of the whole vehicle, and maximum permissible power generation amount W1 by the first motor-generator 2 for ensuring that first motor temperature Tm detected by the temperature sensor 32a is held to or below upper limit temperature Tmb. Further, when a request for temperature increase suppression of the first motor-generator 2 is output, the first motor-generator 2 is controlled so as to generate electric power of maximum permissible power generation amount W1. However, instead of the above configuration, power generation by a first motor-generator can be stopped and a second motor-generator can generate electric power of required power generation amount. Therefore, the power generation calculation unit 403 may not need to calculate maximum permissible power generation amount W1, and thus the configuration of a power generation calculation unit is not limited to the above configuration.

Although in the above embodiment, temperature of the first motor-generator 2 is detected by the temperature sensor 32a, a physical quantity having a correlation with temperature of the first motor-generator may be detected, and thus the configuration of a temperature detection part is not limited to the above configuration. Therefore, suppression request output unit 402 may output a request for temperature increase suppression based on signal from sensor or the like other than the temperature sensor 32a. Although in the above embodiment, target route is set by the navigation unit 36, a route setting unit is not limited to the above configuration. Although in the above embodiment, the position of the vehicle 100 is detected by using signal from the GPS unit 34, the configuration of a position detection part is not limited to the above configuration. Therefore, the configuration of a travel determination unit for determining whether the vehicle travels straight ahead is not limited to the above configuration. Although in the above embodiment a state of charge (SOC) of the battery 12 is detected by the battery sensor 32b, the configuration of a SOC detection part is not limited to the above configuration.

In the above embodiment, when the straight travel determination unit 401 determines that the vehicle 100 travels straight ahead, the second control is implemented to perform regeneration by the second motor-generator 3 and to increase driving force of the engine 1, and when, to the contrary, the straight travel determination unit 401 determines that the vehicle 100 does not travel straight ahead, performance of the second control is prohibited. Namely, a configuration is adopted whereby the second control is permitted or prohibited based on straight-ahead traveling as a condition. Optionally, however, the second control can be permitted or prohibited in response to some other condition affecting travel stability of the vehicle 100.

For example, it is possible to use the communication unit 37 to acquire weather information from an external source and to prohibit the second control when rain, snow or other condition likely to destabilize behavior of the vehicle 100 is forecast. And rather than acquiring weather information, it is alternatively possible to equip the vehicle 100 with a rain sensor and use it to detect presence or absence of precipitation. Also possible is to permit or prohibit the second control based on signals from a camera capable of discerning weather condition. To cope with susceptibility of the vehicle 100 to unstable behavior on an unpaved road, the second control can be prohibited when other that a paved road is detected from road surface data acquired from a camera or the like. Optionally, the second control can be prohibited on roads other than expressways, for example. The second control can also optionally be prohibited during hill climbing and hill descent. A further option is to prohibit the second control when deviation between load acting on the front wheels and load acting on the rear wheels is equal to or greater than a predetermined value. The second control can also optionally be prohibited when diameters of the front and rear tires are different. Prohibiting the second control is also an option when engine coolant temperature is low owing to low outside temperature, to the engine 1 having just been cold-started, or some other cause. In other words, a travel determination unit can be configured as various types of determination units other than the straight travel determination unit 401.

Although in the above embodiment, the control apparatus 50 is applied to the self-driving vehicle 100, a control apparatus of a hybrid vehicle according to the present invention can be also applied to vehicle other than the self-driving vehicle.

The present invention can also be used as a control method of a hybrid vehicle which includes an internal combustion engine and a first motor-generator configured to respectively drive one wheels of front wheels and rear wheels, and a second motor-generator configured to drive the other wheels of the front wheels and the rear wheels.

The above embodiment can be combined as desired with one or more of the above modifications. The modifications can also be combined with one another.

According to the present invention, it is possible to resolve charge deficiency of the battery while simultaneously suppressing temperature increase of a first motor-generator.

Above, while the present invention has been described with reference to the preferred embodiments thereof, it will be understood, by those skilled in the art, that various changes and modifications may be made thereto without departing from the scope of the appended claims.

What is claimed is:

1. A control apparatus of a hybrid vehicle, the hybrid vehicle including an internal combustion engine and a first motor-generator configured to respectively drive one wheels of front wheels and rear wheels, and a second motor-generator configured to drive the other wheels of the front wheels and the rear wheels,
the control apparatus comprising:
a temperature detection part configured to detect a temperature of the first motor-generator; and
an electronic control unit including a microprocessor and a memory connected to the microprocessor, wherein
the microprocessor is configured to perform:
controlling the internal combustion engine, the first motor-generator and the second motor-generator so that the hybrid vehicle travels in accordance with a required driving force;
outputting a request for a temperature increase suppression of the first motor-generator based on the temperature of the first motor-generator detected by the temperature detection part; and
the controlling including controlling the internal combustion engine, the first motor-generator and the second motor-generator, so as to perform a first control in which the first motor-generator generates an electric power by a torque from the internal combustion engine when the request for the temperature increase suppression is not output, while so as to perform a second control in which a power generation amount of the first motor-generator generated by the torque from the internal combustion engine is reduced, the second motor-generator generates an electric power by a regenerative torque and a driving force of the internal combustion engine increases by an amount corresponding to the regenerative torque when the request for the temperature increase suppression is output.

2. The control apparatus according to claim 1, wherein
the microprocessor is configured to further perform:
calculating a required power generation amount required for a whole of the hybrid vehicle and a maximum permissible power generation amount of the first motor-generator so that the temperature detected by the temperature detection part is limited to a predetermined temperature; and
the controlling including controlling the first motor-generator and the second motor-generator so that the first motor-generator generates the maximum permissible power generation amount and the second motor-generator generates a target power generation amount obtained by subtracting the maximum permissible power generation amount from the required power generation amount when the request for the temperature increase suppression is output.

3. The control apparatus according to claim 2, further comprising
a SOC detection part configured to detect a state of charge of a battery in which the electric power generated by the first motor-generator and the electric power generated by the second motor-generator are stored, wherein
the predetermined temperature is a first predetermined temperature, and
the microprocessor is configured to perform
the outputting including outputting the request for the temperature increase suppression when the state of charge detected by the SOC detection part is less than or equal to a predetermined value and the temperature of the first motor-generator detected by the temperature detection part is higher than or equal to a second predetermined temperature, the second predetermined temperature being lower than the first predetermined temperature.

4. The control apparatus according to claim 1, wherein
the microprocessor is configured to further perform
determining whether a travel stability of the hybrid vehicle is maintained, and
the controlling including controlling the internal combustion engine, the first motor-generator and the second motor-generator so as to perform the second control when the request for the temperature increase suppression is output and it is determined that the travel stability is maintained, while so as not to perform the second control even if the request for the temperature increase suppression is output when it is determined that the travel stability is not maintained.

5. The control apparatus according to claim 4, wherein
the microprocessor is configured to perform
the determining including determining whether the hybrid vehicle travels straight ahead, and
the controlling including controlling the internal combustion engine, the first motor-generator and the second motor-generator so as to perform the second control when the request for the temperature increase suppression is output and it is determined that the hybrid vehicle travels straight ahead, while so as not to perform the second control even if the request for the temperature increase suppression is output when it is determined that the hybrid vehicle does not travel straight ahead.

6. The control apparatus according to claim 5, further comprising
a position detection part configured to detect a position of the hybrid vehicle, wherein
the microprocessor is configured to further perform
setting a target route of the hybrid vehicle,
the hybrid vehicle is a self-driving vehicle configured to autonomously travel along the target route set, and
the microprocessor is configured to perform
the determining including determining whether the hybrid vehicle travels straight ahead based on the target route and the position of the hybrid vehicle detected by the position detection part.

7. A control apparatus of a hybrid vehicle, the hybrid vehicle including an internal combustion engine and a first motor-generator configured to respectively drive one wheels of front wheels and rear wheels, and a second motor-generator configured to drive the other wheels of the front wheels and the rear wheels,
the control apparatus comprising:
a temperature detection part configured to detect a temperature of the first motor-generator; and
an electronic control unit including a microprocessor and a memory connected to the microprocessor, wherein
the microprocessor is configured to function as:
a control unit configured to control the internal combustion engine, the first motor-generator and the second motor-generator so that the hybrid vehicle travels in accordance with a required driving force; and
a suppression request output unit configured to output a request for a temperature increase suppression of the first motor-generator based on the temperature of the first motor-generator detected by the temperature detection part, and
the control unit is configured to control the internal combustion engine, the first motor-generator and the second motor-generator, so as to perform a first control in which the first motor-generator generates an electric power by a torque from the internal combustion engine when the request for the temperature increase suppression is not output from the suppression request output unit, while so as to perform a second control in which a power generation amount of the first motor-generator generated by the torque from the internal combustion engine is reduced, the second motor-generator generates an electric power by a regenerative torque and a driving force of the internal combustion engine increases by an amount corresponding to the regenerative torque when the request for the temperature increase suppression is output from the suppression request output unit.

8. The control apparatus according to claim 7, wherein
the microprocessor is configured to further function as
a power generation calculation unit configured to calculate a required power generation amount required for a whole of the hybrid vehicle and a maximum permissible power generation amount of the first motor-generator so that the temperature detected by the temperature detection part is limited to a predetermined temperature, and
the control unit is configured to control the first motor-generator and the second motor-generator so that the first motor-generator generates the maximum permissible power generation amount calculated by the power generation calculation unit and the second motor-generator generates a target power generation amount obtained by subtracting the maximum permissible power generation amount from the required power generation amount calculated by the power generation calculation unit when the request for the temperature increase suppression is output from the suppression request output unit.

9. The control apparatus according to claim 8, further comprising
a SOC detection part configured to detect a state of charge of a battery in which the electric power generated by the first motor-generator and the electric power generated by the second motor-generator are stored, wherein
the predetermined temperature is a first predetermined temperature, and
the suppression request output unit is configured to output the request for the temperature increase suppression when the state of charge detected by the SOC detection part is less than or equal to a predetermined value and the temperature of the first motor-generator detected by the temperature detection part is higher than or equal to a second predetermined temperature, the second predetermined temperature being lower than the first predetermined temperature.

10. The control apparatus according to claim 7, wherein
the microprocessor is configured to further function as
a travel determination unit configured to determine whether a travel stability of the hybrid vehicle is maintained, and
the control unit is configured to control the internal combustion engine, the first motor-generator and the second motor-generator so as to perform the second control when the request for the temperature increase suppression is output and it is determined by the travel determination unit that the travel stability is maintained, while so as not to perform the second control even if the request for the temperature increase suppression is output when it is determined by the travel determination unit that the travel stability is not maintained.

11. The control apparatus according to claim 10, wherein
the travel determination unit includes a straight travel determination unit configured to determine whether the hybrid vehicle travels straight ahead, and
the control unit is configured to control the internal combustion engine, the first motor-generator and the second motor-generator so as to perform the second control when the request for the temperature increase suppression is output and it is determined by the straight travel determination unit that the hybrid vehicle travels straight ahead, while so as not to perform the second control even if the request for the temperature increase suppression is output when it is determined by the straight travel determination unit that the hybrid vehicle does not travel straight ahead.

12. The control apparatus according to claim 11, further comprising
a position detection part configured to detect a position of the hybrid vehicle, wherein
the microprocessor is configured to further function as
a route setting unit configured to set a target route of the hybrid vehicle,
the hybrid vehicle is a self-driving vehicle configured to autonomously travel along the target route set by the route setting unit, and
the travel determination unit is configured to determine whether the hybrid vehicle travels straight ahead based on the target route set by the route setting unit and the position of the hybrid vehicle detected by the position detection part.

13. A control method of a hybrid vehicle, the hybrid vehicle including an internal combustion engine and a first motor-generator configured to respectively drive one wheels of front wheels and rear wheels, and a second motor-generator configured to drive the other wheels of the front wheels and the rear wheels,
the control method comprising:
detecting a temperature of the first motor-generator;
controlling the internal combustion engine, the first motor-generator and the second motor-generator so that the hybrid vehicle travels in accordance with a required driving force; and
outputting a request for a temperature increase suppression of the first motor-generator based on the temperature of the first motor-generator, wherein
the controlling includes controlling the internal combustion engine, the first motor-generator and the second motor-generator, so as to perform a first control in which the first motor-generator generates an electric power by a torque from the internal combustion engine when the request for the temperature increase suppression is not output, while so as to perform a second control in which a power generation amount of the first motor-generator generated by the torque from the internal combustion engine is reduced, the second motor-generator generates an electric power by a regenerative torque and a driving force of the internal combustion engine increases by an amount corresponding to the regenerative torque when the request for the temperature increase suppression is output.

14. The control method according to claim 13, further comprising
calculating a required power generation amount required for a whole of the hybrid vehicle and a maximum permissible power generation amount of the first motor-generator so that the temperature is limited to a predetermined temperature, wherein
the controlling includes controlling the first motor-generator and the second motor-generator so that the first motor-generator generates the maximum permissible power generation amount and the second motor-generator generates a target power generation amount obtained by subtracting the maximum permissible power generation amount from the required power generation amount when the request for the temperature increase suppression is output.

15. The control method according to claim 14, further comprising
detecting a state of charge of a battery in which the electric power generated by the first motor-generator and the electric power generated by the second motor-generator are stored, wherein
the predetermined temperature is a first predetermined temperature, and
the outputting includes outputting the request for the temperature increase suppression when the state of charge detected in the detecting is less than or equal to a predetermined value and the temperature of the first motor-generator detected in the detecting is higher than or equal to a second predetermined temperature, the second predetermined temperature being lower than the first predetermined temperature.

16. The control method according to claim 13, further comprising
determining whether a travel stability of the hybrid vehicle is maintained, wherein
the controlling includes controlling the internal combustion engine, the first motor-generator and the second motor-generator so as to perform the second control when the request for the temperature increase suppression is output and it is determined that the travel stability is maintained, while so as not to perform the second control even if the request for the temperature increase suppression is output when it is determined that the travel stability is not maintained.

17. The control method according to claim 16, wherein
the determining includes determining whether the hybrid vehicle travels straight ahead, and
the controlling includes controlling the internal combustion engine, the first motor-generator and the second motor-generator so as to perform the second control when the request for the temperature increase suppression is output and it is determined that the hybrid vehicle travels straight ahead, while so as not to perform the second control even if the request for the temperature increase suppression is output when it is determined that the hybrid vehicle does not travel straight ahead.

18. The control method according to claim 17, further comprising
detecting a position of the hybrid vehicle; and
setting a target route of the hybrid vehicle, wherein
the hybrid vehicle is a self-driving vehicle configured to autonomously travel along the target route, and
the determining includes determining whether the hybrid vehicle travels straight ahead based on the target route and the position of the hybrid vehicle.
